(19) United States
(12) Patent Application Publication
(10) Pub. No.: US 2014/0370372 A1
(43) Pub. Date: Dec. 18, 2014

(54) Pouch-Type Battery, and Apparatus and Method for Sealing Pouch-Type Battery

(71) Applicant: SK Innovation Co.,Ltd., Seoul (KR)

(72) Inventor: Ming Zhe Kong, Daejeon (KR)

(21) Appl. No.: 14/373,045

(22) PCT Filed: Dec. 20, 2012
(86) PCT No.: PCT/KR2012/011141

§ 371 Date: Jul. 18, 2014

(30) Foreign Application Priority Data
Jan. 20, 2012 (KR) 10-2012-0006727

(51) Int. Cl. H01M 10/04; H01M 2/08

(52) U.S. Cl. CPC H01M 10/049; H01M 10/0404; H01M 2/08
USPC 429/185; 156/580; 156/146

(57) ABSTRACT

Provided are an apparatus and a method for sealing a pouch-type battery. The apparatus for sealing a pouch-type battery includes sealing tools disposed above and below a sealing part of a pouch, respectively, wherein the sealing tools are disposed so that the sealing part is sealed while having a thickness difference. As described above, the sealing part is sealed while having the thickness difference, thereby making it possible to prevent a phenomenon that the sealing part made of polypropylene, or the like, is pushed into the pouch.

### TECHNICAL FIELD

The present invention relates to a pouch-type battery in which a battery assembly including an anode, a separator, and a cathode is put in a pouch-type package, an electrolyte is injected into the pouch-type package, and an edge is sealed, and an apparatus and method for sealing the same.

### BACKGROUND ART

Generally, in a pouch-type battery, a battery assembly including an anode, a separator, and a cathode is put in a pouch-type package, an electrolyte is injected into the pouch-type package, and an edge is sealed.

That is, sealing tools are disposed above and below a sealing part of an edge of a pouch and press the sealing part to apply pressure and heat to the sealing part, thereby sealing the sealing part.

However, a method for sealing a pouch-type battery according to the related art has the following problems.

Since the sealing part is sealed at a constant thickness when being sealed, a phenomenon that the sealing part is pushed into the pouch occurs.

Therefore, interference with the electrolyte occurs due to the pushed sealing part, and a phenomenon that the sealing part attaches to the separator in the pouch occurs.

### RELATED ART DOCUMENT

Korean Patent Laid-Open Publication No. 10-2011-0039011 (published on Apr. 15, 2011 and entitled ‘Method of Manufacturing Pouch-Type Battery and Apparatus of Sealing Pouch’)

### DISCLOSURE

### Technical Problem

An object of the present invention is to provide a pouch-type battery capable of preventing a sealing part from being pushed into a pouch, and an apparatus and a method for sealing the same.

### Technical Solution

In one general aspect, an apparatus for sealing a pouch-type battery in which a battery assembly including an anode, a cathode, and a separator is positioned in a pouch, an electrolyte is injected in the pouch, and the pouch is sealed, includes: sealing tools disposed above and below a sealing part of the pouch, respectively, wherein the sealing tools are disposed so as to seal the sealing part so that a thickness of the sealing part becomes thinner from an inner side of the sealing part toward an outer side thereof.

The sealing tools may be disposed so as to be inclined so that they become closer to each other from the inner side of the sealing part toward the outer side thereof.

In another general aspect, a method for sealing a pouch-type battery, includes: an electrode assembly putting step of putting an electrode assembly in a pouch; an electrolyte injecting step of injecting an electrolyte into the pouch; and a sealing step of sealing an edge of the pouch, wherein in the sealing step, a sealing part at which the pouch is sealed is sealed so that a thickness thereof becomes thinner from an inner side thereof toward an outer side thereof.

In still another general aspect, a pouch-type battery includes: a battery assembly including an anode, a cathode, and a separator; a pouch having the battery assembly positioned therein; and an electrolyte injected into the pouch, wherein a sealing part at which the pouch is sealed has a thickness that becomes thinner from an inner side thereof toward an outer side thereof.

### Advantageous Effects

The pouch-type battery and the apparatus and the method for sealing the same according to an exemplary embodiment of the present invention have the following effects.

The sealing part is sealed while having a thickness difference, thereby making it possible to prevent a phenomenon that the sealing part made of polypropylene, or the like, is pushed into the pouch.

Further, since the sealing part is not pushed into the pouch, interference with an electrolyte in the pouch may be prevented, and a phenomenon that the sealing part attaches to a separator in the pouch may be prevented.

In addition, the sealing part of the pouch is enhanced, thereby making it possible to further increase stability.

### DESCRIPTION OF DRAWINGS

FIG. 1 is a conceptual diagram showing an apparatus for sealing a pouch-type battery according to an exemplary embodiment of the present invention.

FIG. 2 is a flow chart showing a method for sealing a pouch-type battery according to an exemplary embodiment of the present invention.

FIG. 3 is an exploded diagram of a pouch-type battery according to an exemplary embodiment of the present invention.

FIG. 4 is a cross-sectional view of the pouch-type battery according to an exemplary embodiment of the present invention.

### BEST MODE

Hereinafter, exemplary embodiments of the present invention will be described in detail with reference to the accompanying drawings. Terms and words used in the present specification and claims are not to be construed as a general or dictionary meaning, but are to be construed as meaning and concepts meeting the technical ideas of the present invention based on a principle that the present inventors may appropriately define the concepts of terms in order to describe their inventions in best mode.

Therefore, configurations described in exemplary embodiments and the accompanying drawings of the present invention do not represent all of the technical spirits of the present invention, but are merely most preferable embodiments. Therefore, the present invention should be construed as including all the changes, equivalents, and substitutions included in the spirit and scope of the present invention at the time of filing this application.

In a pouch-type battery, a battery assembly including an anode, a cathode, and a separator is put in a pouch-type package, an electrolyte is injected into the pouch-type package, and an edge is sealed.

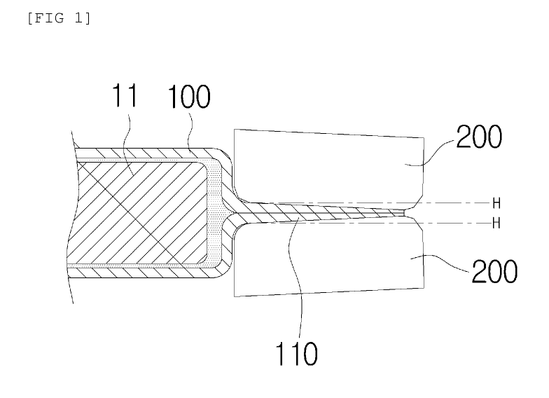

A sealing apparatus for sealing the edge of the pouch-type battery is shown in FIG. 1.

As shown in FIG. 1, the sealing apparatus of the pouch-type battery according to an exemplary embodiment of the present invention includes sealing tools 200 disposed above and below a sealing part 110 of a pouch 100, respectively. The sealing part 110 may be made of a material such as polypropylene, or the like.

Here, it is preferable that the sealing tools 200 are disposed so that the sealing part 110 is sealed while having a thickness difference.

In the present exemplary embodiment, the sealing tools 200 disposed above and below the sealing part 110, respectively, are disposed so as to be inclined, respectively, so that they become closer to each other from an inner side of the sealing part 110 toward an outer side thereof.

That is, the sealing tools 200 are disposed so as to be inclined, respectively, so that a cross-sectional area is decreased toward the inner side in a direction in which the sealing part 110 is inserted.

As shown in FIG. 1, an outer side of the sealing part 110 is formed in an inner side of a horizontal line H.

The inner side of the sealing part 110 described above means a portion at which the battery assembly is positioned, and the outer side thereof means a direction opposite to the portion at which the battery assembly is positioned.

The sealing tools 200 disposed above and below the sealing part 110, respectively, press the sealing part 110 above and below the sealing part 110, respectively, to apply pressure and heat to the sealing part 110, thereby compressing the sealing part to seal the sealing part.

When the sealing part 110 is sealed by the inclined sealing tools 200 as described above, the sealing part 110 is sealed so that a thickness of the sealing part 110 becomes thinner from the inner side of the sealing part 110 toward the outer side thereof.

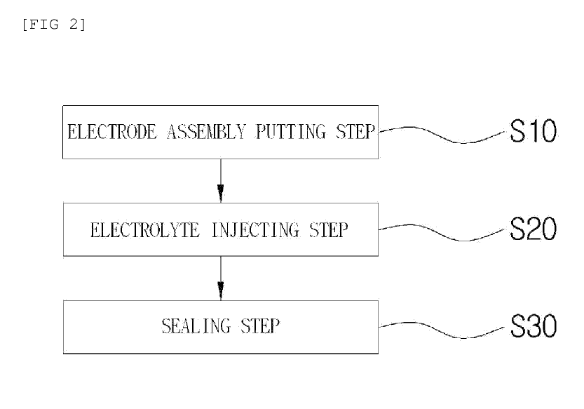

A method for sealing a pouch-type battery according to an exemplary embodiment of the present invention will be described with reference to FIG. 2.

The method for sealing a pouch-type battery according to an exemplary embodiment of the present invention includes an electrode assembly putting step S10, an electrolyte injecting step S20, and a sealing step S30.

In the electrode assembly putting step S10, the battery assembly 11 including an anode, a cathode, and a separator is put in the pouch 100.

The pouch 100 is manufactured in a pouch form having an opened upper portion. Generally, two pouch members are overlapped with each other to seal both side portions and a lower portion except for an upper portion, and the battery assembly 11 is put through the opened upper portion. The pouch 100 may also be used by folding the pouch member and sealing only both side portions.

In the electrolyte injecting step S20, an electrolyte is injected into the pouch 100 subjected to the electrode assembly putting step S10.

In the sealing step S30, an edge of the pouch 100 is sealed. In this case, at the time of sealing the sealing part 110 of the edge, it is preferable that the sealing part 110 is sealed so as to have a thickness difference, and preferably, so that a thickness of the sealing part 110 becomes thinner from the inner side thereof toward the outer side thereof.

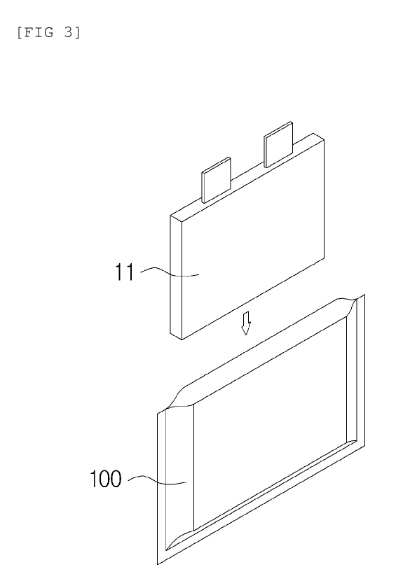

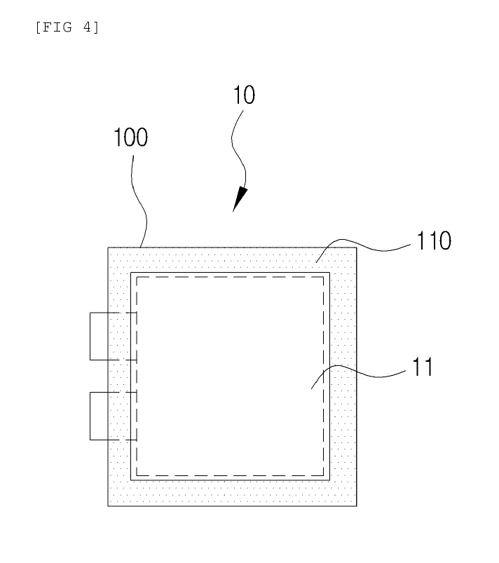

A pouch-type battery according to an exemplary embodiment of the present invention will be described in detail with reference to FIGS. 3 and 4.

The pouch-type battery 10 includes the battery assembly 11, the pouch 100, and the electrolyte.

The battery assembly 11 includes the anode, the cathode, and the separator.

The pouch 100 has the battery assembly 11 positioned therein. As shown in FIG. 3, portions of the pouch 100 except for an upper portion of the pouch 100 are sealed, and the battery assembly 11 is inserted through the opened upper portion.

The electrolyte is injected into the pouch 100 to serve as a medium of ionic conduction when electrolysis occurs in the battery assembly 11.

Here, the pouch 100 is characterized in that a thickness of the sealed sealing part 110 is thinner from the inner side thereof toward the outer side thereof.

With the apparatus and the method for sealing a pouch-type battery according to an exemplary embodiment of the present invention, the sealing part is sealed while having the thickness difference, thereby making it possible to prevent a phenomenon that the sealing part made of the polypropylene, or the like, is pushed into the pouch.

Further, since the sealing part is not pushed into the pouch, interference with the electrolyte in the pouch may be prevented, and a phenomenon that the sealing part attaches to the separator in the pouch may be prevented.

In addition, the sealing part of the pouch is enhanced, thereby making it possible to further increase stability.

Hereinabove, although the present invention has been described with reference to exemplary embodiments and the accompanying drawings, the present invention is not limited thereto, but may be variously modified and altered by those skilled in the art to which the present invention pertains without departing from the spirit and scope of the present invention claimed in the claims.

### DETAILED DESCRIPTION OF MAIN ELEMENTS

10: Pouch-type battery

11: Battery assembly

100: Pouch

110: Sealing part

200: Sealing tool

1. An apparatus for sealing a pouch-type battery in which a battery assembly including an anode, a cathode, and a separator is positioned in a pouch, an electrolyte is injected in the pouch, and the pouch is sealed, comprising:
sealing tools disposed above and below a sealing part of the pouch, respectively,
wherein the sealing tools are disposed so as to seal the sealing part so that a thickness of the sealing part becomes thinner from an inner side of the sealing part toward an outer side thereof.

2. The apparatus for sealing a pouch-type battery of claim 1, wherein the sealing tools are disposed so as to be inclined so that they become closer to each other from the inner side of the sealing part toward the outer side thereof.

3. A method for sealing a pouch-type battery, comprising:
an electrode assembly putting step of putting an electrode assembly in a pouch;
an electrolyte injecting step of injecting an electrolyte into the pouch; and
a sealing step of sealing an edge of the pouch,
wherein in the sealing step, a sealing part at which the pouch is sealed is sealed so that a thickness thereof becomes thinner from an inner side thereof toward an outer side thereof.

4. A pouch-type battery comprising:
a battery assembly including an anode, a cathode, and a separator;
a pouch having the battery assembly positioned therein; and
an electrolyte injected into the pouch,
wherein a sealing part at which the pouch is sealed has a thickness that becomes thinner from an inner side thereof toward an outer side thereof.
